(19) United States
(12) Patent Application Publication
(10) Pub. No.: US 2011/0204174 A1
(43) Pub. Date: Aug. 25, 2011

(54) SINGLE PULL WIRE WINDING DEVICE

(75) Inventor: WEN-WEI SUN, TAIPEI COUNTY (TW)

(73) Assignees: WANG WANG DAH ENTERPRISE CO., LTD., TAIPEI COUNTY (TW); DONG GUAN TOP DEN ELECTRONICS LIMITED COMPANY, GIANGDONG (CN)

(21) Appl. No.: 12/710,524

(22) Filed: Feb. 23, 2010

(51) Int. Cl. H02G 11/02; B65H 75/48; B65H 75/44

(52) U.S. Cl. 242/385.4

(57) ABSTRACT

A single pull wire winding device comprises a wire winding reel; the wire winding reel has two recesses respectively on both surfaces thereof for containing a flexible printed board and a coil spring, the wire winding reel having a peripheral groove on its periphery for containing a power connection wire, and a bulkhead on one side of the peripheral groove has at least one stopping portion; a switch is provided within the containing groove along a tangential direction of the wire winding reel so that the stopping block of the switch engages with the stopping portion of the wire winding reel to stop the rotation of the wire winding reel. Thus, the present invention, wherein a flatter flexible printed board is used to substitute for a portion of a thicker power connection wire to reduce the volume of the assembled device, is widely applied to various electronic products.

### BACKGROUND OF THE INVENTION

1. Field of the Invention

The present invention relates to a wire storage technique applied to electronic products, and more particularly to a single pull wire winding device in which a flexible printed board is used to substitute for a portion of a conventional power connection wire and which comprises a retrieval switch.

2. Description of the Related Art

When common electronic products are connected with each other or connected to a computer device for use, they are signally connected or electrically connected with each other through a connection wire. Such connection wires can be categorized as being directly connected to the electronic products, or as extension wires for cascade and extension, or the like. In general, the problem, that the wire is in a mess because it is not easy for the wire to be stored easily occurs after the wire has been used. Therefore, currently, wire winders are often used to store such connection wires in order to quickly store such connection wires, and it can prevent the wires from break or wear due to pulling and dragging after the wires have been stored. Referring to FIG. 1, there is a schematic view showing a structure of a conventional wire winder. As shown in the figure, the wire winder 10 is assembled of a fixed seat 11, a reel 12, a wire 13, a spiral spring 14, an engagement means 15 and a cover 16. The wire 13 is wound around the peripheral wall of the reel 12 and contained therein. The spiral spring 14 is disposed within the reel 12. One end of the swing arm 151 of the engagement apparatus 15 is pressed so that the propping end 152 at the other end tilts outward to release the engagement with the stop edge 121 preset on the periphery of the reel 12. Consequently, the spiral spring 14 between the fixed seat 11 and the reel 12 releases energy to rotate the reel 12 so that the wire 13 is automatically retracted and wound around the peripheral wall of the reel 12, thereby significantly enhancing the convenience in use.

However, a single type of the wire 13, namely a common power connection wire coated with insulating rubber, is currently used in most electronic products. Such power connection wires have a larger volume due to the coating of rubber. It is easy to occupy a very large storage space when the wire is wound and received in the reel 12. Accordingly, such wire winders 10 must have a larger volume in order to have a larger storage space. Nonetheless, the trend for the majority of current electronic products is toward smallness and compactness, but the service length of the wire 13 from the current wire winder 10 is limited by the volume of the fixed seat 11 and the reel 12 as well as a lack of the internal storage space, which causes inconvenience in use and needs to be improved.

Therefore, the inventors designed a single pull wire winding device, in which a flat flexible printed board and a power connection wire wrapped with insulating rubber can be simultaneously contained, thereby reducing the space occupied by the volume of the wire, capable of effectively reducing the volume of the assembled device, and increasing the length of the wire in use. This significantly enhances the convenience in use.

### SUMMARY OF THE INVENTION

An object of the present invention aims to provide a single pull wire winding device so that two segments of wires of different volumes can be used simultaneously to reduce the volume of the assembled device and increase the length of the wire to be disposed.

To achieve this object, a single pull wire winding device of the present invention comprises: a housing having a containing groove; a wire winding reel pivotally disposed within the containing groove, the wire winding reel having two recesses respectively on both surfaces thereof for containing a flexible printed board and a coil spring, one end of the coil spring being fixedly mounted within the recess of the wire winding reel, the other end of the coil spring being fixedly mounted within the slot, the wire winding reel having a peripheral groove on the periphery thereof, a power connection wire being wound and disposed within the peripheral groove, the power connection wire being connected with the flexible printed board, and a bulkhead on one side of the peripheral groove having at least one stopping portion; and a switch provided within the containing groove along a tangential direction of the wire winding reel to engage with the stopping portion of the wire winding reel.

In one embodiment, a shaft is provided at the center of the containing groove and the wire winding reel has a shaft hole at the center thereof so that the wire winding reel is pivotally connected to the shaft. A slot is provided on the top of the shaft for the installation of the flexible printed board within the recess of the wire winding reel. Furthermore, at least one communication hole is provided between the recess on one face of the wire winding reel and the peripheral groove so that the flexible printed board within the recess passes through the communication hole to connect with the power connection wire within the peripheral groove. The housing is further disposed with a top cover for closing the housing.

Thus, according to the present invention, a flatter flexible printed board is wound and disposed within the recess on one face of the wire winding reel, and a thicker power connection wire is wound and disposed within the peripheral groove of the wire winding reel. The space occupied by the power connection wire, all of which is used in the prior art, can be reduced by the connection of the flexible printed board and the power connection wire, so as to achieve the purpose of lightweight and compact design.

Another object of the present invention aims to offer a switch structure of a single pull wire winding device so that a wire can be extended for use or retracted for storage by engagement to significantly enhance the convenience in use.

To achieve this object, a switch of the present invention further includes a level, a spring, a tension spring and a stopping block. The level is coupled with the spring. The stopping block is coupled with the tension spring. The level is connected with the stopping block, whereby the stopping block rests against the stopping portion to achieve the effect of positioning the wire winding reel. The level is provided with a stop block and a pushing block. The stop block is connected with one end of the stopping block, and the pushing block rests against the spring. Furthermore, when the wire is extended for use, the stopping block rests against the wire winding reel to achieve the effect of positioning the wire. After the level is pushed, the restoring force of the coil spring guides the power connection wire again to return to the wire winding reel, thereby significantly enhancing the convenience in use.

### BRIEF DESCRIPTION OF THE DRAWINGS

FIG. 1 is a schematic view showing a structure of a conventional wire winder.

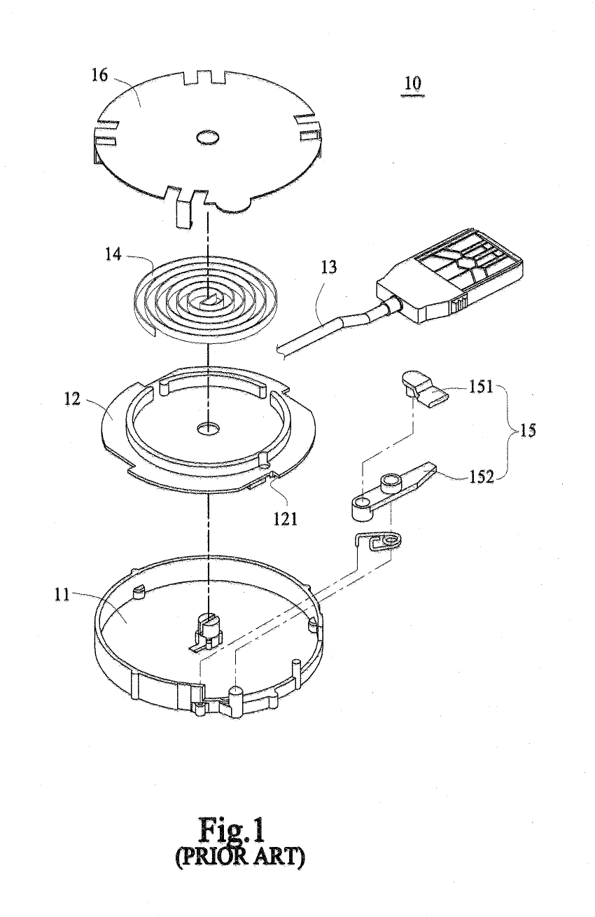

FIG. 2 is a three-dimensional exploded view of a preferred embodiment of the present invention.

FIG. 3 is a three-dimensional appearance view of a preferred embodiment of the present invention after assembled.

FIG. 4 is a schematic view (I) showing a state of a preferred embodiment of the present invention when in use.

FIG. 5 is a schematic view (II) showing a state of a preferred embodiment of the present invention when in use.

### DETAILED DESCRIPTION OF THE PREFERRED EMBODIMENTS

The contents of the present invention will become more apparent from the following description when taken in conjunction with the drawings.

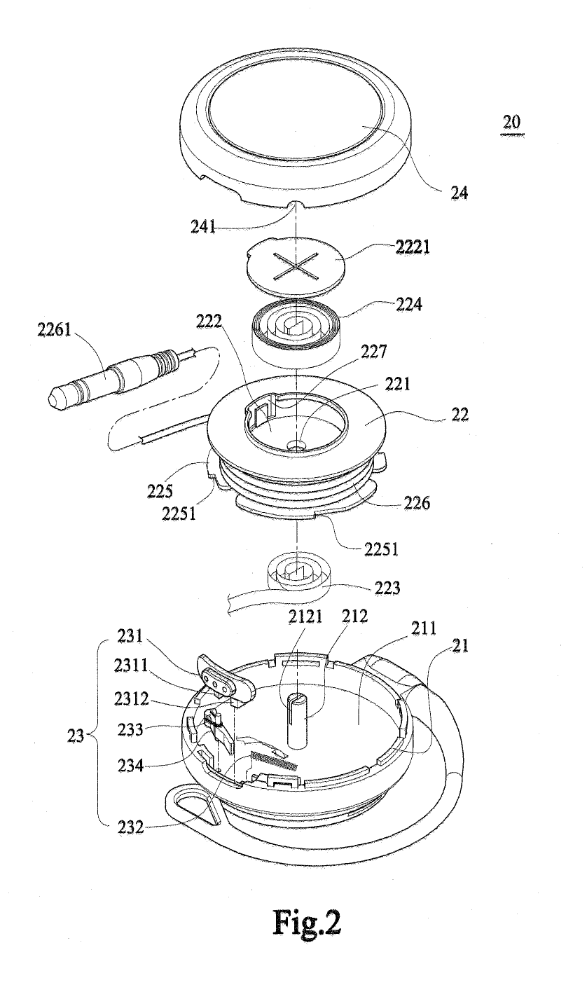

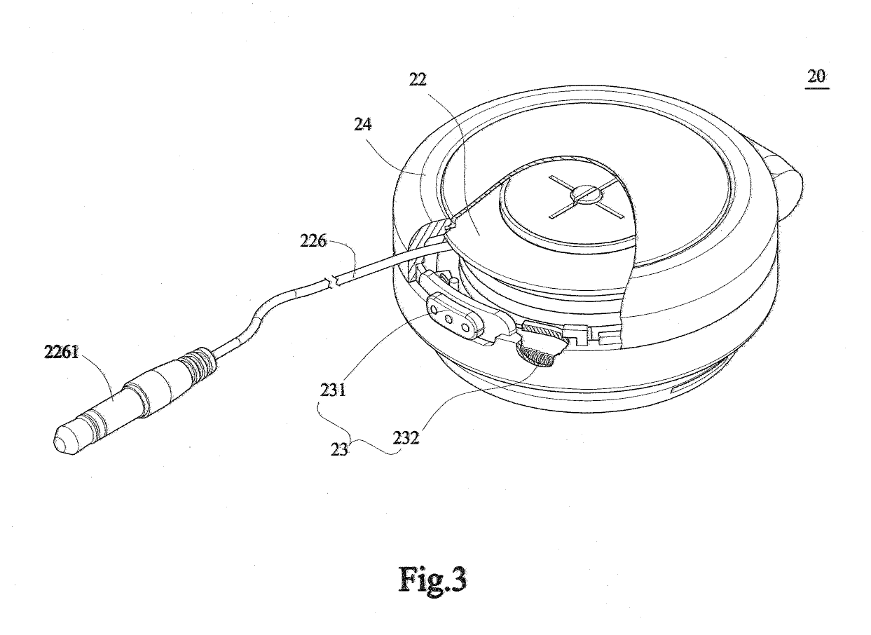

Referring to FIGS. 2 and 3, there are shown a three-dimensional exploded view of a preferred embodiment of the present invention and a three-dimensional appearance view of a preferred embodiment of the present invention after assembled. As shown in these figures, a single pull wire winding device 20 of the present invention comprises a housing 21, a wire winding reel 22 and a switch 23.

The housing 21 has a containing groove 211 at the center thereof. A shaft 212 is provided at the center of the containing groove 211, and a slot 2121 is provided on the top of the shaft 212.

The wire winding reel 22 has a shaft hole 221 at the center thereof so that the wire winding reel 22 is pivotally connected to the shaft 212. The wire winding reel 22 has two recesses 222 respectively on both surfaces thereof for respectively containing a flexible printed board 223 and a coil spring 224. The flexible printed board 223 is wound and disposed within one of the recesses 222. The coil spring 224 is disposed within the recess 222 on the other face. One end of the coil spring 224 is fixedly mounted within the recess 222 of the wire winding reel 22, and the other end thereof is fixedly mounted within the slot 2121. Additionally, the recess 222 is disposed with a cover 2221 for enclosing the coil spring 224 within the recess 222. The wire winding reel 22 rotates with respect to the housing 21 so that the coil spring 224 rotates forward and is compressed to store energy or rotates backward to release energy. The flexible printed board 223 may rotate forward or backward as the wire winding reel 22 rotates, thus generating changes in the length (due to extension or retraction). The wire winding reel 22 has a peripheral groove 225 on the periphery thereof. A power connection wire 226 is wound and disposed within the peripheral groove 225. One end of the power connection wire 226 is connected with the flexible printed board 223, and the other end thereof is connected with an adaptor 2261 for signal connection. A bulkhead on one side of the peripheral groove has at least one stopping portion 2251. Furthermore, at least one communication hole 227 is provided between the recess 222 of the wire winding reel 22, within which the flexible printed board 223 is disposed, and the peripheral groove 225, so that the flexible printed board 223 passes through the communication hole 227 to connect with the power connection wire 226 within the peripheral groove 225.

The switch 23 further includes a level 231, a spring 232, a tension spring 233 and a stopping block 234. The level 231 is coupled with the spring 232. The stopping block 234 is coupled with the tension spring 233. The level 231 is connected with the stopping block 234, whereby the spring 232 pushes the stopping block 234 to rest against the stopping portion 2251 of the wire winding reel 22 to provide an engagement effect for limiting the rotation of the wire winding reel. Furthermore, the level 231 is provided with a stop block 2311 and a pushing block 2312. The stop block 2311 is connected with one end of the stopping block 234. The pushing block 2312 rests against the spring 232. The level 231 is provided within the containing groove 211 along a tangential direction of the wire winding reel 22 to engage the stopping block 234 with the stopping portion 2251 of the wire winding reel 22.

Furthermore, the housing 21 is further disposed thereon with a top cover 24. The top cover 24 has a shape corresponding to the shape of the housing 21 for closing the housing 21. The above-described members are enclosed within the containing space defined by the top cover 24 and the housing 21. The top cover 24 further has a through hole 241 to allow the power connection wire 226 to pass therethrough, which has no influence on its service functions and thus will be explained in no more detail.

Thus, according to the present invention, the flatter flexible printed board 223 is wound and disposed within the recess 222 on one face of the wire winding reel 22, and then one end portion of the flexible printed board 223 passes through the communication hole 227 and is connected with one end portion of the thicker power connection wire 226, and the power connection wire 226 is wound and disposed within the peripheral groove 225 of the wire winding reel 22. The space occupied by the power connection wire 226, all of which is used in the prior art, can be reduced by the connection of the flexible printed board 223 and the power connection wire 226, so as to achieve the purpose of lightweight and compact design.

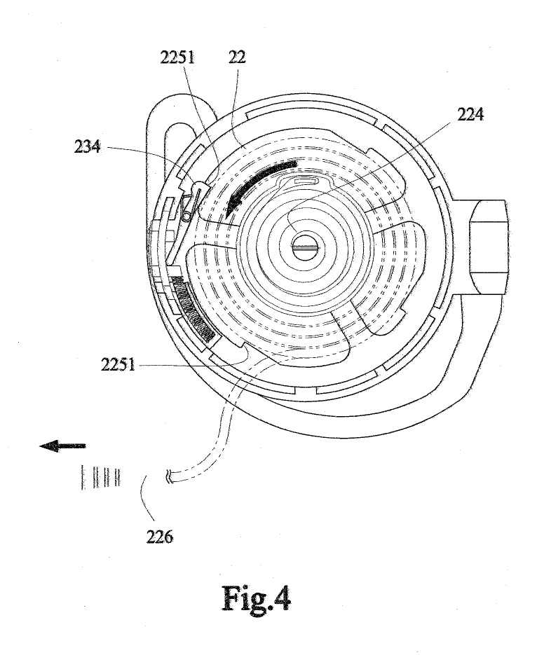

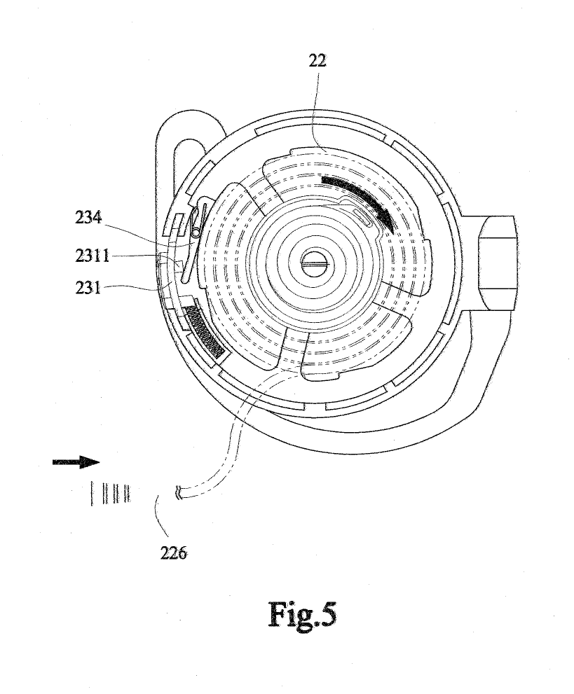

Referring to FIGS. 4 and 5, there are schematic views showing states of a preferred embodiment of the present invention when in use. Also, referring to FIG. 2, when a user draws out the power connection wire 226 for use, the wire winding reel 22 is driven to rotate forward so that the coil spring 224 is compressed to store energy and the stopping block 234 rests against the stopping portion 2251 on the periphery of the wire winding reel 22 to achieve the effect of positioning the wire. Furthermore, after the user pushes the level 231, the stop block 2311 of the level 231 is driven to push the stopping block 234 to be separated from the stopping portion 2251. Meanwhile, the restoring force generated after the coil spring is released drives the wire winding reel 22 to rotate backward so that the power connection wire is guided again to return to the wire winding reel 22. It is very convenient and simple for the user to operate this device with one hand, thereby significantly enhancing the convenience in use.

As described above and as shown in FIGS. 2 to 5, the present invention has the following advantages in practice:
1. The present invention provides a single pull wire winding device, in which two segments of wires of different volumes are simultaneously disposed in the wire winding reel 22, so as to reduce the required storage volume and the volume of the assembled device, thus further increasing the length of the wire to be disposed.
2. Furthermore, according to the present invention, the structure of the switch 23 is provided for controlling the wire winding reel 22 to rotate forward or backward. It is easy to control the wire to be extended for use or retracted for storage by engagement with the stopping portion 2251 on the periphery of the wire winding reel 22, thus significantly enhancing the convenience in use.

However, what are described above are only preferred embodiments of the invention and should not be used to limit the scope of the present invention, and therefore all equivalent changes and modifications, such as the configuration and size of the housing and the top cover, the shape of the wire winding reel, or the structure and shape of the switch, which do not depart from the spirit and scope of the present invention should be included in the appended claims.

In summarization of the foregoing description, the single pull wire winding device according to the present invention meets the requirements of inventiveness and industrial applicability of patents, and the application for a utility model patent is duly filed accordingly.

What is claimed is:

1. A single pull wire winding device provided for winding and storing a segment of a power connection wire and for the convenience of pulling out the power connection wire for use, comprising:
a housing, having a containing groove;
a wire winding reel, pivotally disposed within the containing groove, the wire winding reel having two recesses respectively on both surfaces of the wire winding reel for containing a flexible printed board and a coil spring, one end of the coil spring being fixedly mounted within the recess of the wire winding reel, the other end of the coil spring being fixedly mounted to the housing, the wire winding reel having a peripheral groove on the periphery of the wire winding reel for winding and containing the power connection wire, and a bulkhead on one side of the peripheral groove having at least one stopping portion; and
a switch, provided within the containing groove along a tangential direction of the wire winding reel, the switch including a level, a spring, a tension spring and a stopping block, the level being coupled with the spring, the stopping block being coupled with the tension spring, and the level being connected with the stopping block; whereby the stopping block rests against the stopping portion to achieve the effect of positioning the wire winding reel.

2. The single pull wire winding device as described in claim 1, wherein a shaft is provided at the center of the containing groove and the wire winding reel has a shaft hole at the center of the wire winding reel so that the wire winding reel is pivotally connected to the shaft.

3. The single pull wire winding device as described in claim 2, wherein a slot is provided on the top of the shaft for the installation of the flexible printed board within the recess of the wire winding reel.

4. The single pull wire winding device as described in claim 1, wherein at least one communication hole is provided between the recess on one face of the wire winding reel and the peripheral groove so that the flexible printed board within the recess passes through the communication hole to connect with the power connection wire within the peripheral groove.

5. The single pull wire winding device as described in claim 1, wherein the level is provided with a stop block and a pushing block, the stop block is connected with one end of the stopping block, and the pushing block rests against the spring.

6. The single pull wire winding device as described in claim 1, wherein the housing is further disposed with a top cover for closing the housing.
